(19) United States
(12) Patent Application Publication
(10) Pub. No.: US 2016/0223727 A1
(43) Pub. Date: Aug. 4, 2016

(54) OPTICAL UNIT, OPTICAL ELEMENT AND METHOD FOR MANUFACTURING THE SAME

(71) Applicant: CANON KABUSHIKI KAISHA, Ohta-ku, Tokyo (JP)

(72) Inventors: Shigeru SUGIYAMA, Yokohama-shi (JP); Keiichi ISHIZUKA, Musashino-shi (JP); Osamu MORISAKI, Kawasaki-shi (JP)

(21) Appl. No.: 15/021,909

(22) PCT Filed: Sep. 2, 2014
(86) PCT No.: PCT/JP2014/004498

§ 371 Date: Mar. 14, 2016

(30) Foreign Application Priority Data
Sep. 18, 2013 (JP) 2013-192616

(51) Int. Cl. G02B 5/08; B21J 5/00

(52) U.S. Cl. CPC G02B 5/0816; B21J 5/00

(57) ABSTRACT

An optical unit, including: an optical element which includes a plurality of reflecting portions and a connecting portion configured to connect the plurality of reflecting portions; a holding member configured to hold the optical element; and a positioning portion provided in the holding member and configured to guide a light beam that has been reflected by the plurality of reflecting portions to a predetermined position, wherein a positioning reference portion configured to be in contact with the positioning portion is provided in the connecting portion.

### TECHNICAL FIELD

The present invention relates to an optical unit which forms an optical image by an optical element that includes a plurality of reflective surfaces, an optical element and a method for manufacturing the same.

### BACKGROUND ART

When an optical element, which is made by press-molding a metal or glass or by plating, is to be attached to a substrate, it is necessary to provide a positioning reference surface in the optical element for the positioning regarding optical design.

An exemplary method for providing such a positioning reference surface in an optical element includes providing a surface that regulates an outer portion of the optical element in a mold with which the optical element is molded, and forming a positioning reference surface in the optical element. Further, a method for machining an outer portion of an optical element after molding and then forming a positioning reference surface is common.

PTL 1 discloses a method for forming positioning; holes in flat portions of an optical element as illustrated in FIG. 6.

### CITATION LIST

### Patent Literature

PTL 1: Japanese Patent Laid-Open No. 2004-264656

### SUMMARY OF INVENTION

### Technical Problem

A method for press-molding an optical element including a plurality of reflective surfaces while bending a molding material into a roof shape, however, has the following problem during formation of a positioning reference surface.

In a case in which a reference surface which regulates an outer portion of the optical element is to be provided, it is necessary to provide reference surface which regulates the outer portion of the optical element in a mold with which the optical element is molded, and to transfer the reference surface to a molding material with high accuracy.

Therefore, a volume of a cavity to be formed by the mold and a volume of the molding material are coincident with each other, the cavity is filled with the molding material, and the reference surface is transferred to the molding material.

However, in a case in which the volume of the molding material is smaller than the volume of the cavity, the filling amount of the molding material in the cavity becomes insufficient and thus it is difficult to transfer the reference surface to the molding material with high accuracy.

Further, in a case in which the volume of the molding material is larger than the volume of the cavity, the filling amount of the molding material in the cavity becomes excessive and flowability of the molding material decreases, whereby distortion, wrinkles and burrs that may cause deterioration in accuracy are created in the optical element. For this reason, precise weight control for the molding material is required, which is a cause of an increase in cost.

Further, in the method of PTL 1, since it is necessary to machine the positioning holes in the molding material in advance or to machine the positioning holes in the optical element after molding, the number of process steps increases, which becomes a cause of an increase in cost.

In view of the above mentioned problems, an object of the present invention is to provide an optical unit that is easy in molding and mold processing and is capable of positioning during attachment to a substrate with high accuracy without affecting optical performance, an optical element and a method for manufacturing the same.

An optical unit of the present invention includes: an optical element which includes a plurality of reflecting portions and a connecting portion configured to connect the plurality of reflecting portions; a holding member configured to hold the optical element; and a positioning portion provided in the holding member and configured to guide a light beam that has been reflected by the plurality of reflecting portions to a predetermined position, wherein a positioning reference portion configured to be in contact with the positioning portion is provided in the connecting portion.

An optical element of the present invention includes: a plurality of reflecting portions; and a connecting portion configured to connect the plurality of reflecting portions; wherein planar portions are provided on side surfaces of the reflecting portions in a longitudinal direction, and planes disposed at 90 degrees with respect to the planar portions are formed in the connecting portion.

A method for manufacturing an optical element of the present invention comprises manufacturing the optical element by bending a single plate-shaped member by press-molding.

### Advantageous Effects of Invention

According to the present invention, an optical unit that is easy in molding and mold processing and is capable of positioning during attachment to a substrate with high accuracy without affecting optical performance, an optical element and a method for manufacturing the same can be implemented.

Further features of the present invention will become apparent from the following description of exemplary embodiments with reference to the attached drawings.

### BRIEF DESCRIPTION OF DRAWINGS

FIG. 1 is a perspective view of an optical element of an embodiment of the present invention seen from the side of reflective surfaces.

FIG. 2A is a perspective view of an optical element of an embodiment of the present invention seen from a back side.

FIG. 2B is an enlarged view of a positioning reference portion.

FIG. 2C is an enlarged view of a positioning reference portion.

FIG. 3A is a diagram illustrating a method for manufacturing an optical element of an embodiment of the present invention, illustrating a process of molding an optical element.

FIG. 3B is a diagram illustrating a method for manufacturing an optical element of an embodiment of the present invention, illustrating a process of molding an optical element.

FIG. 3C is a diagram illustrating a method for manufacturing an optical element of an embodiment of the present invention, illustrating a process of molding an optical element.

FIG. 4A is a perspective view of a mold used in an embodiment of the present invention, illustrating a core mold.

FIG. 4B is a perspective view of a mold used in an embodiment of the present invention, illustrating a cavity mold.

FIG. 5A is a perspective view illustrating a holding member of an optical unit of an embodiment of the present invention.

FIG. 5B is a perspective view illustrating a state in which an optical element is attached to a holding member in an optical unit of an embodiment of the present invention.

FIG. 6 is a perspective view of an optical element to which a related art is applied.

### DESCRIPTION OF EMBODIMENTS

Hereinafter, an optical element which includes a plurality of reflection members in an embodiment of the present invention will be described with reference to the accompanying drawings.

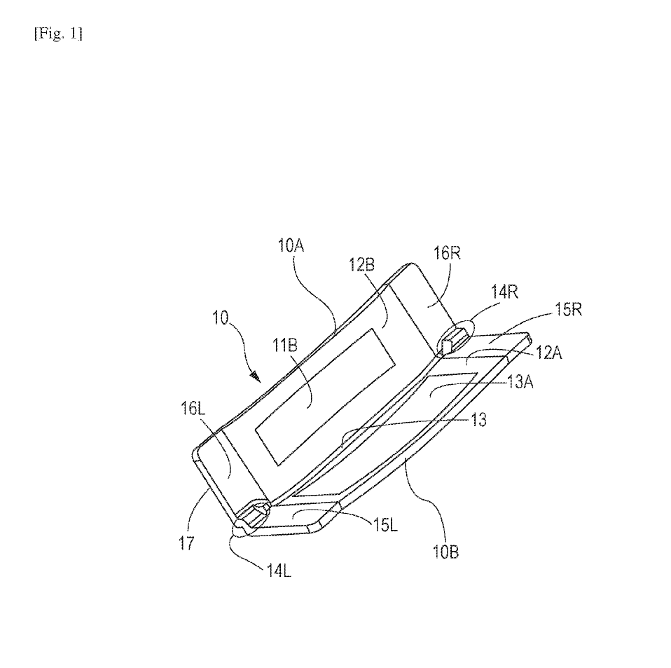

FIG. 1 illustrates a perspective view of an optical element 10 according to an embodiment of the present invention seen from the side of reflective surfaces (which are surfaces on which light is reflected).

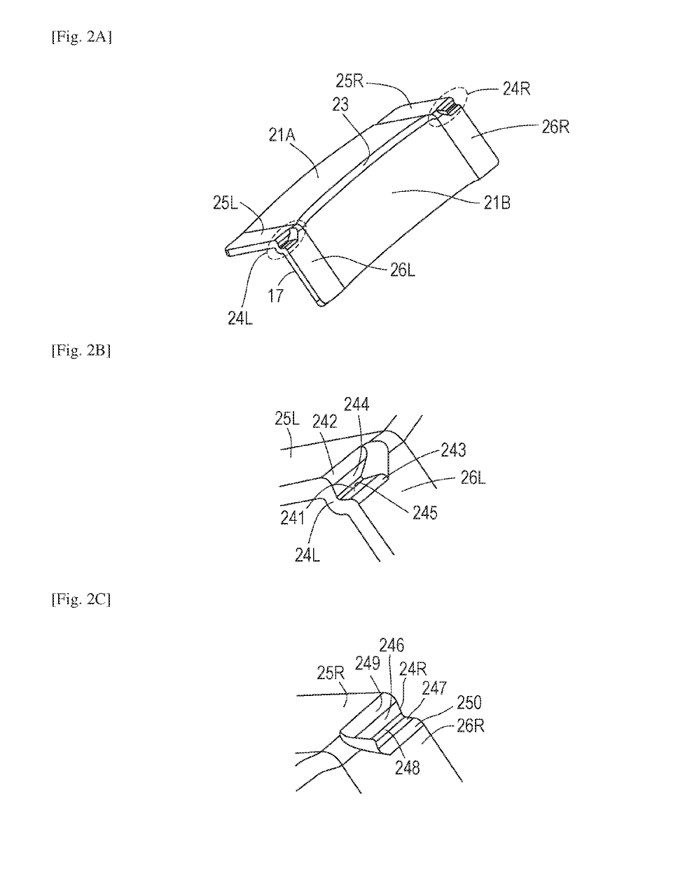

FIG. 2A is a perspective view of the optical element 10 according to an embodiment of the present invention seen from a back side (i.e., a reverse side) of the reflective surfaces (which are the surfaces on which light is reflected).

The optical element 10 will be described with reference to FIGS. 1 and 2A with the side having the reflective surfaces being referred to as a front side and the side opposite to the reflective surfaces being referred to as a back side (i.e., a reverse side).

The optical element 10 is formed from a single plate-shaped member which includes a plurality of reflecting portions (in FIG. 1, two reflecting portions 10A and 10B) and a connecting portion connecting the plurality of reflecting portions. The connecting portion includes a positioning reference portion.

First, the reflecting portions will be described.

The reflecting portion 10A includes a reflective surface 12A and the reflecting portion 10B includes a reflective surface 12B. An optically-designed optical curved surface portion 11A is formed on the reflective surface 12A and an optically-designed optical curved surface portion 11B is formed on the reflective surface 12B so as to fulfill optical functions as optical elements.

The reflective surface 12A is designed to include the optically-designed optical curved surface portion 11A and a portion smoothly continued from the optical curved surface portion 11A. The reflective surface 12B is designed to include the optically-designed optical curved surface portion 11B and a portion smoothly continued from the optical curved surface portion 11B. Planar portions 15L and 15R may be formed at both end portions of the reflective surface 12A in a longitudinal direction. Planar portions 16L and 16R may be formed at both end portions of the reflective surface 12B in a longitudinal direction.

In the reflecting portion, a surface 21A and a surface 21B are formed on the back sides (i.e., the reverse sides) of the reflective surfaces 12A and 12B, respectively.

The surface 21A and the surface 21B are formed in the shape in which a thickness of the optical element 10 is reduced from those of surfaces formed by the reflective surfaces 12A and 12B.

Planar portions 25L and 25R are formed at both end portions of the surface 21A in the longitudinal direction. Planar portions 26L and 26R are formed at both end portions of the surface 21B in the longitudinal direction. Although an example in which the planar portions are formed at both end portions of the surface 21A and at both end portions of the surface 21B in the longitudinal direction is illustrated in the present embodiment, the planar portions 25L and 25R may be formed at both end portions of either of the surface 21A or the surface 21B. The planar portion 25L, and the planar portion 25R are used as the positioning reference portion for positioning a bottom surface (in a height direction) of the optical element 10 (i.e., for regulating parallel eccentricity). Therefore, the planar portion 25L and the planar portion 25R are desirably formed on the same plane.

A planar portion 17 formed as a plane is provided on the at least one side surface in the longitudinal direction of at least either one of the reflecting portion 10A or the reflecting portion 10B. The planar portion 17 is formed to be at 90 degrees with respect to the planar portion 25L and the planar portion 25R. Although it is sufficient to provide at least one planar portion in the present embodiment, this configuration is not restrictive: a plurality of planar portions may be provided.

The planar portion 17 is used as a positioning reference portion for positioning a side surface (in the longitudinal direction) of the optical element 10 (i.e., for regulating parallel eccentricity).

Next, the connecting portion will be described.

The connecting portion which connects a plurality of the reflecting portions is formed by a connecting surface 13 which connects the reflective surface 12A and the reflective surface 12B, and a connecting surface 23 which connects the surface 21A and the surface 21B. The connecting surface is desirably formed by a curved surface R.

Next, the positioning reference portion will be described,

The positioning reference portion will be described with reference to FIGS. 2B and 2C.

The positioning reference portion is formed in the connecting portion. FIGS. 2B and 2C illustrate an example of the positioning reference portion in which a recessed portion 24L is formed between the planar portion 25L and the planar portion 26L and a recessed portion 24R is formed between the planar portion 25R and the planar portion 26R. Therefore, a projection 14L and a projection 14R (see FIG. 1) may be formed on corresponding surfaces.

Next, the recessed portion 24L and the recessed portion 24R which are an example of the positioning reference portion will be described.

A planar portion 244 is formed in the recessed portion 24L. A planar portion 246 is formed in the recessed portion 24R.

The planar portion 244 is designed to be 90 degrees with respect to the planar portion 25L and the planar portion 17. The planar portion 246 is designed to be 90 degrees with respect to the planar portion 25R and the planar portion 17.

Since the planar portion 244 and the planar portion 246 are used as the positioning reference portion for positioning the central portion (in a width direction) of the optical element 10 (i.e., for regulating parallel eccentricity), the planar portion 244 and the planar portion 246 are desirably formed on the same plane. Although an example in which two planar portions, i.e., the planar portion 244 and the planar portion 246 are used for the positioning is described here, any one of the planar portions may be formed and positioning is executed using that plane may also be possible.

As described above, the optical element 10 may be positioned with high accuracy by regulating parallel eccentricity in the height direction, the longitudinal direction and the width direction of the optical element 10 by using the planar portion 17, the planar portion 25L, the planar portion 25R, the planar portion 244 and the planar portion 246 as the positioning reference portions.

Although an example in which the positioning reference portion for attaching the optical element to the connecting surface on the back side of reflective surfaces is formed has been mainly described above, this is not restrictive: for example, the positioning reference portion may be formed on the connecting surface of the reflective surfaces. The planar portion 25L and the planar portion 244 are disposed at 90 degrees with respect to each other and the planar portion 25R and the planar portion 246 are disposed at 90 degrees with respect to each other to provide the positioning reference portions in the present embodiment. However, the planar portion 26L and the planar portion 245 may be disposed at 90 degrees with respect to each other and the planar portion 26R and the planar portion 247 disposed at 90 degrees with respect to each other to provide the positioning reference portion.

Further, the positioning reference portion may be provided on the front side. In a case in which the positioning reference portion is provided on the front side, a positioning planar portion is provided in the projection 14L and the projection 14R in FIG. 1. In particular, a planar portion of the projection 14L may be formed at 90 degrees with respect to the planar portion 15L and a planar portion of the projection 14R may be formed at 90 degrees with respect to the planar portion 15R.

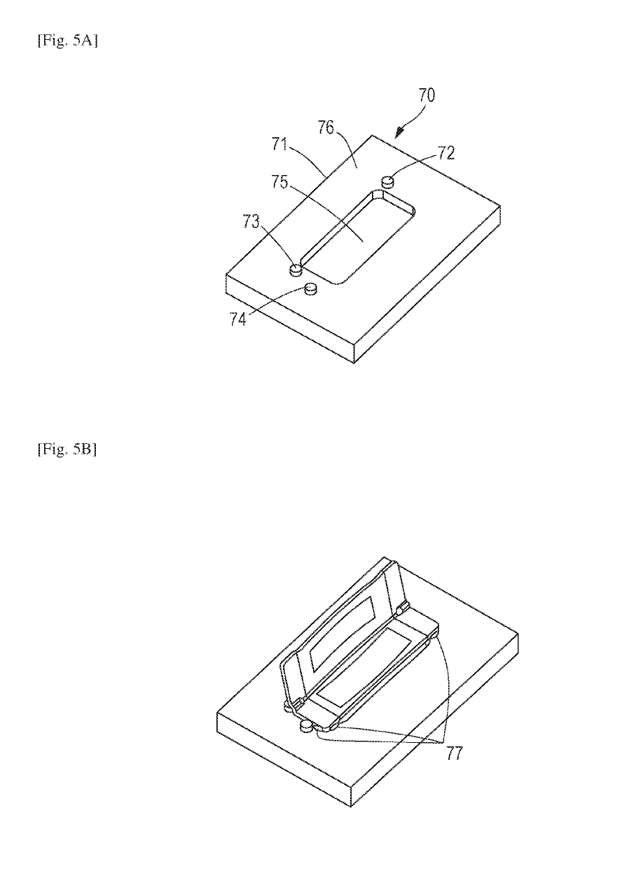

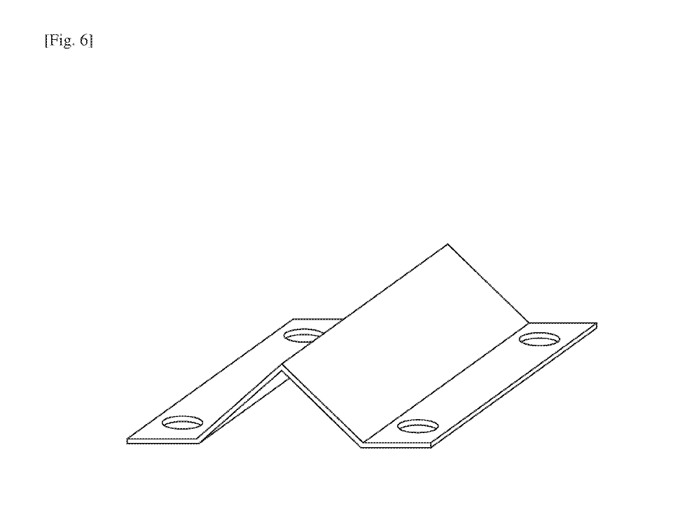

Next, the optical unit according to an embodiment of the present invention wil be described with reference to FIGS. 5A and 5B.

FIG. 5A illustrates a holding member 70 to which the optical element according to an embodiment of the present invention is attached. A positioning portion is formed in the holding member 70. By bringing the optical element into contact with the positioning portion, it is possible to guide a light beam reflected on optical curved surfaces of a plurality of reflective surfaces formed in the optical element to a predetermined position. The illustrated holding member 70 of the present embodiment is an example in which three cylindrical pins as positioning portions are press-fit in a plate member 71.

These pins 72, 73 and 74 which are the positioning portions are used for positioning of the optical element 10. If the shape of the positioning portions is cylindrical, a contact area between the positioning portions and the plane of the positioning reference portion is small, whereby it is possible to position the optical element 10 at a correct position without considering the form accuracy of the positioning portion very seriously. However, the shape of the positioning; portions is not limited to the same: a polygonal prism shape or other shapes may also be employed. Further, the press-fit of the pins is not restrictive: integral molding or any other forming methods may also be employed. A recessed portion 75 is formed near the center of the plate member 71. This recessed portion 75 avoids interference between the surface 21A on the back side of the optical element 10 and a surface 76 of the plate member 71 when the optical element 10 is attached to the holding member 70.

Next, a state in which the optical element 10 in the embodiment of the present invention is attached to the holding member 70 will be described with reference to FIGS. 2A to 2C and 5B.

The planar portion 246 of the optical element 10 is brought into contact with the pin 72, the planar portion 244 of the optical element 10 is brought into contact with the pin 73, and the planar portion 17 of the optical element 10 is brought into contact with the pin 74 of the holding member 70. The optical element 10 is disposed so that the planar portions 25L and 25R of the optical element 10 are simultaneously brought into contact with the surface 76 of the plate member 71 of the holding member 70.

Although an example in which the pin 72 and the pin 73 are brought into contact with the planar portions 246 and 244 of the optical element 10 is described in the present embodiment, this configuration is not restrictive and various other forms may be employed. For example, positioning may be executed only by the planar portion 246 and the pin 72. Although an example in which the planar portion 17 of the optical element 10 is brought into contact with the pin 74 is illustrated, two pins may be brought into contact with the planar portion 17 or, alternatively, two planar portions may be provided each of which may be brought into contact with a pin.

Next, the optical element 10 is fixed to the holding member 70. This fixation may be performed by a well-known technique. For example, the optical element 10 is fixed to the holding member 70 with an epoxy adhesive 77 applied to a boundary portion of the planar portions 25L and 25R of the optical element 10 and the surface 76 of the plate material 71.

With such an attaching method, the optical element 10 may be attached to a designed position and thus desired optical performance may be obtained.

As described above, the optical unit according to an embodiment of the present invention is capable of positioning the optical element with high accuracy in a configuration in which molding and mold processing is easy without the need of complicated structure in the mold or the need of executing additional processing to the optical element after molding.

This optical unit may be suitably used, for example as an optical system of an image reading apparatus, such as a copier. Therefore, the optical unit may be reduced in size and weight and, at the same time, is capable of reading with high accuracy.

Next, a method for manufacturing the optical element 10 according to an embodiment of the present invention will be described.

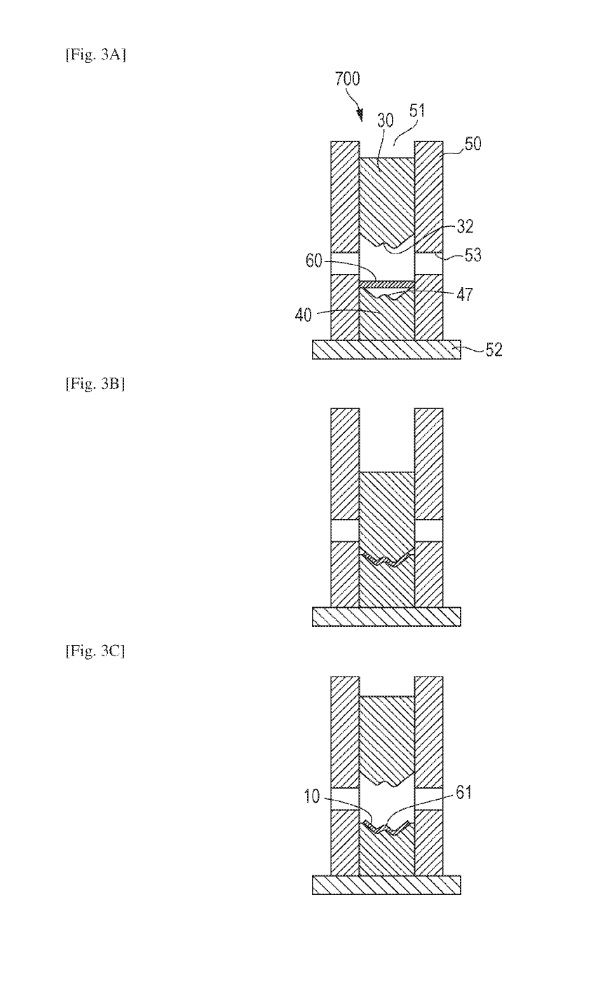

FIG. 3A is a schematic diagram of a mold 700 used to mold the optical element 10 in an embodiment of the present invention.

An upper mold core 30 which is a piece for forming the front side of the optical element 10 and a lower mold cavity 40 which is apiece for forming the back side are inserted in a pocket 51 of a drum mold 50. The drum mold 50 is used to guide the upper mold core 30. The lower mold cavity 40 is fixed to a bottom plate 52 with an unillustrated bolt.

The upper mold core 30 is fixed to a shaft, which is moved up and down, of a molding machine by an unillustrated bolt, clamp or the like. When the shaft is moved up and down, the upper mold core 30 is moved up and down inside the pocket 51 while being guided by the drum mold 50.

Therefore, relative positions of the front side and the back side of the optical element 10 is kept to the accuracy that is equal to or smaller than clearance between the upper mold core 30 and the lower mold cavity 40, and the drum mold 50.

The drum mold 50 includes, on both sides thereof, windows 53 through which the molding material is introduced into the mold 70.

The windows 53 are provided on both sides of the drum mold 50 so that a temperature distribution becomes symmetrical when the mold 70 is heated during the molding process.

Next, configurations of the upper mold core 30 and the lower mold cavity 40 used to mold the optical element 10 in the example of the present invention will be described.

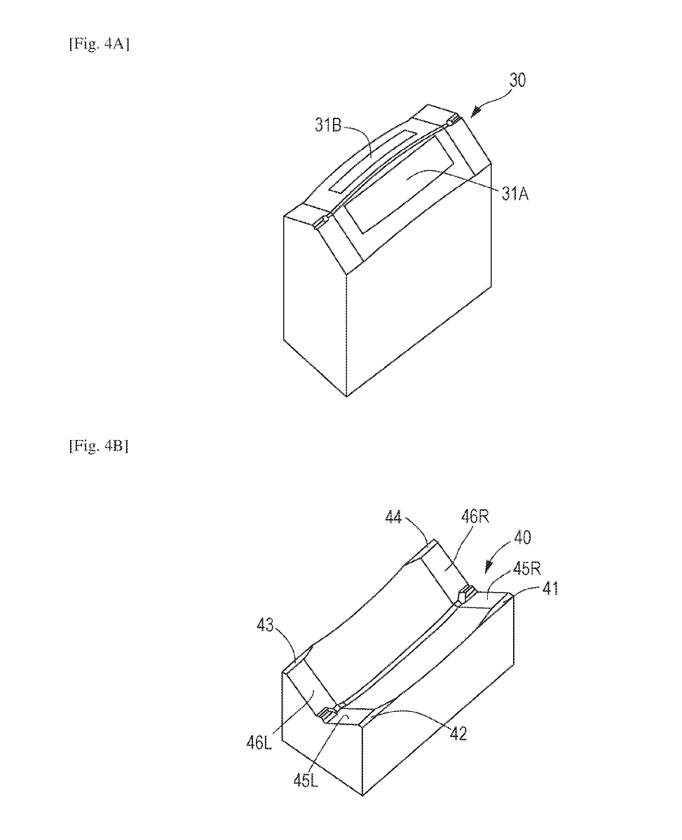

The upper mold core 30 will be described with reference to FIG. 4A. The upper mold core 30 is used to form the front side of the optical element 10.

On the upper mold core 30, the inverted shape of the reflective surface of the optical element 10 is formed. Especially, an optical surface 31A and an optical surface 31B for forming the optical curved surface 11A and the optical curved surface 11B of the optical element 10 are processed with high accuracy.

Next, the lower mold cavity 40 will be described with reference to FIG. 4B.

The lower mold cavity 40 is used to form the back side of the optical element 10. A planar portion 41, a planar portion 42, a planar portion 43 and a planar portion 44 are used to support the molding material introduced into the mold during the molding process, Other shapes are the inverted shapes of the back side of the optical element 10.

Next, a process of press-molding the optical element according to an embodiment of the present invention will be described with reference to FIGS. 3A to 3C.

The molding material may be a metallic material. Amorphous metallic material, such as Zr-based metallic glass, may be desirably used.

Desirably, the mold 700 and the molding machine are disposed in an unillustrated chamber and a space surrounding the mold 700 is substituted with nitrogen.

The bottom plate 52 is fixed to the molding machine by an unillustrated bolt or clamp. Next, a molding material 60 formed by a plate member is held by an unillustrated automatic hand and is disposed on the lower mold cavity 40 through the window 53 of the drum mold 50.

Next, it is desirable to heat the drum mold 50 to a glass transition temperature of the molding material 60 by using an unillustrated cartridge heater and an infrared lamp that are built in the drum mold 50. For example, since the glass transition temperature of Zr-based metallic glass is 450 degrees (celsius), the drum mold 50 is heated to 450 degrees (celsius).

The temperature is measured by, for example, the following manner: an unillustrated hole is formed at a bottom surface of the upper mold core 30 to reach near a surface that acts in molding and an unillustrated hole is formed at a bottom surface of the lower mold cavity 40 to reach near a surface that acts in molding, and a thermocouple is inserted in each hole to measure the temperature of the upper mold core 30 and the lower mold cavity 40.

When the temperature of the upper mold core 30 and the lower mold cavity 40 reach the glass transition temperature of the molding material 60, the upper mold core 30 is made to lower by the molding machine and let the molding material 60 further deform. For example, the pressure to be applied to the upper mold core 30 is set to 20 MPa and pressurizing time is set to 60 seconds, and control is made by the molding machine.

When the set pressure and the set pressurizing time are applied, the molding material 60 is molded into a shape in accordance with the upper mold core 30 and the lower mold cavity 40.

Nitrogen gas is injected into the pressurized mold from an unillustrated valve and the mold is cooled to 300 degrees (celsius) in, for example, 100 seconds. Then, the upper mold core 30 is moved up and the molding material 60 is taken out by using an automatic hand to obtain the optical element 10. Therefore, it is possible to form, for example, an optical element in which a plate-shaped member is bent to form an angled portion having the interior angle smaller than 180 degrees about a connecting surface and includes a reflective surface on the side which has the interior angle. Since a bent portion 61 formed by a recessed portion 32 of the upper mold core 30 and a projection 47 of the lower mold cavity 40 is designed not to regulate extension of the material, neither distortion nor wrinkles is produced in the optical element 10 by forming the bent portion 61.

Further, since the bent portion 61 is deformed first by the recessed portion 32 of the upper mold core 30, it is easy to concentrate the pressure applied by the upper mold core 30, whereby the shape of the recessed portion 32 of the upper mold core 30 and the shape of the projection 47 of the lower mold cavity 40 may be reliably transferred with high accuracy.

### EXAMPLE

Next, Example of the present invention will be described.

In this Example, an example in which 2-mm thick metal optical element is manufactured by press-molding using the mold illustrated in FIGS. 3A to 3C will be described.

In this example, Zr-based metallic glass which is an amorphous metallic material is used as a molding material.

The glass transition temperature of the material is 450 degrees (celsius). The mold 70 and the molding machine were disposed in an unillustrated chamber and a space surrounding the mold 70 was substituted with nitrogen.

The bottom plate 52 was fixed to the molding machine by an unillustrated bolt or clamp. Next, a molding material 60 formed by a plate member was held by an unillustrated automatic hand and was disposed on the lower mold cavity 40 through the window 53 of the drum mold 50.

Next, the drum mold 50 was heated to a glass transition temperature of the molding material 60 by using an unillustrated cartridge heater and an infrared lamp that were built in the drum mold 50.

The temperature is measured by the following manner: an unillustrated hole is formed at a bottom surface of the upper mold core 30 to reach near a surface that acts in molding and an unillustrated hole is formed at a bottom surface of the lower mold cavity 40 to reach near a surface that acts in molding, and a thermocouple is inserted in each hole to measure the temperature of the upper mold core 30 and the lower mold cavity 40.

When the temperature of the upper mold core 30 and the lower mold cavity 40 reached the glass transition temperature of the molding material 60, the upper mold core 30 was made to lower by the molding machine and let the molding material 60 further deform. The pressure to be applied to the upper mold core 30 was set to 20 MPa and pressurizing time was set to 60 seconds, and control was made by the molding machine.

When the set pressure and the set pressurizing time were applied, the molding material 60 was molded into a shape in accordance with the upper mold core 30 and the lower mold cavity 40.

Nitrogen gas was injected into the pressurized mold from an unillustrated valve and the mold was cooled to 300 degrees (celsius) in 100 seconds. Then, the upper mold core 30 was moved up and the molding material 60 was taken out by using an automatic hand to obtain the optical element 10. Therefore, it is possible to form, for example, an optical element in which a plate-shaped member is bent to form an angled portion having the interior angle smaller than 180 degrees about a connecting surface and includes a reflective surface on the side which has the interior angle. Since a bent portion 61 formed by a recessed portion 32 of the upper mold core 30 and a projection 47 of the lower mold cavity 40 is designed not to regulate extension of the material, neither distortion nor wrinkles is produced in the optical element 10 by forming the bent portion 61.

Further, since the bent portion 61 is deformed first by the recessed portion 32 of the upper mold core 30, it is easy to concentrate the pressure applied by the upper mold core 30, whereby the shape of the recessed portion 32 of the upper mold core 30 and the shape of the projection 47 of the lower mold cavity 40 were reliably transferred with high accuracy.

The manufactured optical element 10 includes two reflective surfaces 12A and 12B as illustrated in FIG. 1 and the size of the two reflective surfaces was 10 min×30 mm. The size of the optical curved surface portion 11A included in the reflective surface 12A was 8 mm×25 mm and the size of the optical curved surface portion 11B included in the reflective surface 12B was 5 mm×22 mm.

R of the connecting surface 13 which connects the curved surface 12A and the curved surface 12B was R0.5.

Regarding the back side, the surface 21A and the surface 211B illustrated in FIG. 2A are formed in the shape in which the thickness of the optical element 10, 2 mm, is reduced from that of the reflective surface 12A including the optical curved surface portion 11A and the reflective surface 12B including the optical curved surface portion 11B on the front side.

R of the connecting surface 23 between the surface 21A and the surface 21B was R2.5. Planar portions 25L and 25R are formed at both end portions of the surface 21A in the longitudinal direction. Planar portions 26L and 26R are formed at both end portions of the surface 21B in the longitudinal direction.

An open angle made by the planar portions 25L and 26L, and an open angle made by the planar portions 25R and 26R were 100 degrees and the size thereof was set to 10 mm×5 mm, respectively. The planar portion 25L and the planar portion 25R were formed on the same plane.

The planar portion 17 formed on the side surface of the optical element 10 in longitudinal direction was formed to be 90 degrees with respect to the planar portion 25L and the planar portion 25R.

The recessed portion 24L was formed between the planar portions 25L and 26L and the recessed portion 24R was formed between the planar portions 25R and 26R.

The planar portion 244 was formed in the recessed portion 24L, illustrated in FIG. 2B and the planar portion 246 was formed in the recessed portion 24R illustrated in FIG. 2C. The planar portion 244 and the planar portion 246 were set to be 90 degrees with respect to the planar portion 25L, the planar portion 25R and the planar portion 17, and the size thereof was 1 mm×3 mm, respectively.

The planar portion 244 and the planar portion 246 were formed on the same plane.

The planar portion 245 and the planar portion 247 were provided at positions facing the planar portion 244 and the planar portion 246.

The angle between the planar portion 245 and the planar portion 244 was 100 degrees and the angle between the planar portion 247 and the planar portion 246 was 100 degrees.

These angles were set to 100 degrees in order to avoid interference between the planar portion 245 or the planar portion 247 with their counterparts when the planar portion 244 and the planar portion 246 are used as the positioning reference portions.

A connecting surface 241 which connects the planar portion 244 and the planar portion 245 at R0.5 and a connecting surface 248 which connects the planar portion 246 and the planar portion 247 at R0.5 were formed.

Further, a connecting surface 242 which connects the planar portion 244 and the planar portion 25L at R2.5 and a connecting surface 249 which connects the planar portion 246 and the planar portion 25R at R2.5 were formed.

Further, a connecting surface 243 which connects the planar portion 245 and the planar portion 26L at R2.5 and a connecting surface 250 which connects the planar portion 247 and the planar portion 26R at R2.5 were formed.

The projection 14L and the projection 14R were formed on the front side and were formed in the shape in which the thickness of the optical element 10, 2 mm, was reduced from those of the recessed portion 24L and the recessed portion 24R.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-192616, filed Sep. 18, 2013, which is hereby incorporated by reference herein in its entirety.

1. An optical unit, comprising:
an optical element which includes a plurality of reflecting portions and a connecting portion configured to connect the plurality of reflecting portions;
a holding member configured to hold the optical element; and
a positioning portion provided in the holding member and configured to guide a light beam that has been reflected by the plurality of reflecting portions to a predetermined position,
wherein a positioning reference portion configured to be in contact with the positioning portion is provided in the connecting portion.

2. The optical unit according to claim 1, further comprising a planar portion on a side surface of the reflecting portion in a longitudinal direction, and a positioning portion that is to be brought into contact with the planar portion in the holding member.

3. The optical unit according to claim 1, wherein the optical element includes a planar portion at the end portion of the reflecting portion and brings the planar portion and a surface of the holding member into contact.

4. The optical unit according to claim 2, wherein the positioning reference portion is plane formed to be at 90 degrees with respect to a planar portion of the side surface.

5. The optical unit according to claim 3, wherein the positioning reference portion is a plane formed to be at 90 degrees with respect to a planar portion of the end portion.

6. The optical unit according to claim 1, wherein the optical element is formed from a single plate-shaped member.

7. The optical unit according to claim 6, wherein the plate-shaped member is an amorphous metallic material.

8. The optical unit according to claim 7, wherein the amorphous metallic material is Zr-based metallic glass.

9. An optical element, comprising:
a plurality of reflecting portions; and
a connecting portion configured to connect the plurality of reflecting portions;
wherein planar portions are provided on side surfaces of the reflecting portions in a longitudinal direction, and planes disposed at 90 degrees with respect to the planar portions are formed in the connecting portion.

10. The optical element according to claim 9, wherein a planar portion is provided at an end portion of the reflecting portion.

11. A method for manufacturing an optical element, comprising manufacturing the optical element according to claim 9 by bending a single plate-shaped member by press-molding.

12. The method for manufacturing an optical element according to claim 11, wherein the plate-shaped member is an amorphous metallic material.

13. The method for manufacturing an optical element according to claim 12, wherein the amorphous metallic material is Zr-based metallic glass.
